(19) United States
(12) Patent Application Publication
(10) Pub. No.: US 2025/0116405 A1
(43) Pub. Date: Apr. 10, 2025

(54) MULTI-FUNCTIONAL ELECTRIC GRILL WITH CHARCOAL CAPABILITY AND MULTI-PURPOSE GRIDDLE

(71) Applicant: W.C. BRADLEY CO., Columbus, GA (US)

(72) Inventors: Jorge Escamilla, Phenix City, AL (US); SLEIMAN ABDALLAH, Columbus, GA (US); BRAD GILLESPIE, Columbus, GA (US); Jourdan Norman, Salisbury, NC (US); THOMAS A. PENNER, Columbus, GA (US)

(21) Appl. No.: 18/907,824

(22) Filed: Oct. 7, 2024

Related U.S. Application Data
(60) Provisional application No. 63/542,964, filed on Oct. 6, 2023.

(51) Int. Cl. F24C 1/04; A47J 37/07; F24C 7/06

(52) U.S. Cl. CPC F24C 1/04; A47J 37/0709; F24C 7/065; A47J 2037/0795

(57) ABSTRACT

A grill includes a reflector below a heating clement with a plurality of reflector panels each having a first position oriented parallel to the cooking surface and a second position oriented non-parallel to the cooking surface.

### CROSS-REFERENCE TO RELATED CASES

This application claims the benefit of U.S. provisional patent application Ser. No. 63/542,964, filed on Oct. 6, 2023, and incorporates such provisional application by reference into this disclosure as if fully set out at this point.

### FIELD OF THE INVENTION

This disclosure relates to outdoor cooking devices in general and, more particularly, to an outdoor cooking device with multiple cooking modes and fuel options.

### BACKGROUND OF THE INVENTION

Known electric grills lack the ability to generate thermal energy comparable to equal size gas grills due to voltage and current draw limitation set by residential electric code requirements. Electric grills have a reputation of being slow on heat up time and unable to produce high searing temperature at the cooking surface. Moreover, known electric grills do not offer versatility in cooking methods or fuel source. There is currently no option to easily convert an electric grill to a charcoal cooking device due to added complexity in design and construction of grease and ash management systems. Another problem with portable or smaller sized grills is a lack of storage options for accessories while not in use, where many resort to hanging accessories on the exterior or having no place for storage.

Residential electrical code requirements limit the amount of available energy to power grills. Hence prior electric grills have small footprints compared to gas or charcoal cooking appliances. Using electric grills in cold weather or windy conditions exacerbates this problem. In addition, the limited footprint may not be appropriate to convert the grill into a charcoal cooking device.

Limited energy or power may not allow for adequately heating a griddle above the heating element. Current electric grill designs are not optimized to reduce heat loss and reduce heat recovery time. There is an additional limit to the performance of an electric grill due to the inability to reduce the void under the heating element that creates a high loss of heat. Similarly, the space above the heating element can cause a rate of heat loss due to heat dissipation through the lid and high volume of unused space. These factors cause a slow heat up time, prevent the grill from reaching high maximum temperatures, and extend the time needed for heat recuperation during normal use. The result is an inferior cooking experience.

What is needed is a system and method for addressing the above and related problems.

### SUMMARY OF THE INVENTION

The invention of the present disclosure, in one aspect thereof, comprises a reflector for use in a cooking grill. The reflector includes an outer support ring, and a plurality of reflector panels with tabs attached thereto. The reflector panels are arranged inside the support ring with tabs outside the support ring. The tabs are displaced downward with respect to the support ring to move the reflector panels closer together to close the reflector. The tabs are allowed to elevate thereby allowing the panels to move to increase an amount of space therebetween opening the reflector.

In some embodiments, the tabs are displaced downward by a push ring affixed to a cooking grate. The panels may rotate along an axis to open the reflector. The tabs may pass through the outer support ring via a plurality of openings that allow rotation of the reflector panels along an axis passing through the support ring. The plurality of openings may be triangular.

In other embodiments, the panels rotate downward from the outer support ring to open the reflector. The tabs may pass through the support ring via a plurality of horizontal slots in the outer support ring.

The invention of the present disclosure, in another aspect thereof, comprises a grill. The grill may include a firebox, a food support grate, a solid fuel support grate below the food support grate, a reflector inside the firebox comprising a plurality of reflector panels that have a closed configuration reflecting heat to the food support grate and an open configuration where a reduced amount of heat is reflected, and an electric heating element above the reflector.

The reflector panels may be retained by a support ring. The reflector panels may drop from below a center of the food support grate to move to the open configuration. In other embodiments, each of the plurality of reflector panels rotate along an axis running through the support ring to move into the open configuration.

The reflector panels may each have an attached tab that is displaced to move the reflector panels into the closed configuration. The tabs may be displaced by a push ring affixed to the cooking grate. The tabs may be displaced downward to move the panels into the closed configuration.

Some embodiments include a funnel inside the firebox circumscribing the reflector panels and/or an opening defined in a bottom of the firebox below the funnel. The push ring may define a plurality of slots for interfacing with at least one protrusion in the firebox for setting a predetermined elevation of the push ring.

The invention of the present disclosure, in another aspect thereof, comprises a grill. The grill includes a cooking grate, a fuel support grate below the cooking grate, an electric heating element below the cooking grate, a reflector below the heating element comprising a plurality of reflector panels each having a push tab and each having a first position oriented parallel to the cooking grate and a second position oriented non-parallel to the cooking grate, a support ring retaining the plurality of reflector panels inside the support ring and each of the push tabs outside the support ring when the reflector panels are in the first position, and a push ring affixed to a bottom of the cooking grate, wherein the push ring engages the push tab on each of the plurality of reflector panels to move the plurality of reflector panels to the first position.

Some embodiments further comprise a lid that covers the cooking grate and has a plurality of clips retaining a griddle in a storage location in the lid. A plurality of handles may be affixed to the cooking grate and be spaced apart to accommodate placement of the griddle onto the cooking grate.

### BRIEF DESCRIPTION OF THE DRAWINGS

FIG. 1 is a perspective exploded cutaway view of one embodiment a multi-function grill according to the present disclosure with a heat reflector in an upward position.

FIG. 2 is a perspective exploded cutaway view of the grill of FIG. 1 with the heat reflector in a downward position.

FIG. 3 is a perspective transparent the grill of FIG. 1 highlighting the heat reflector in the upward position.

FIG. 4 is a perspective transparent view of the grill of FIG. 1 highlighting a grate and push ring.

FIG. 5 is a perspective transparent view of the grill of FIG. 1 highlighting a griddle and storage location.

FIG. 6 is a perspective view of one embodiment of an ash management system and deployable reflector for use in a grill according to the present disclosure.

FIG. 7 is a perspective partial cutaway view of another embodiment of a multi-function grill according to the present disclosure.

FIG. 8 is another perspective partial cutaway view of the grill of FIG. 7 showing placement of a griddle on the cooking grate.

FIG. 9 is a front perspective view of the grill of FIG. 1 showing a griddle storage arrangement.

### DETAILED DESCRIPTION OF THE PREFERRED EMBODIMENTS

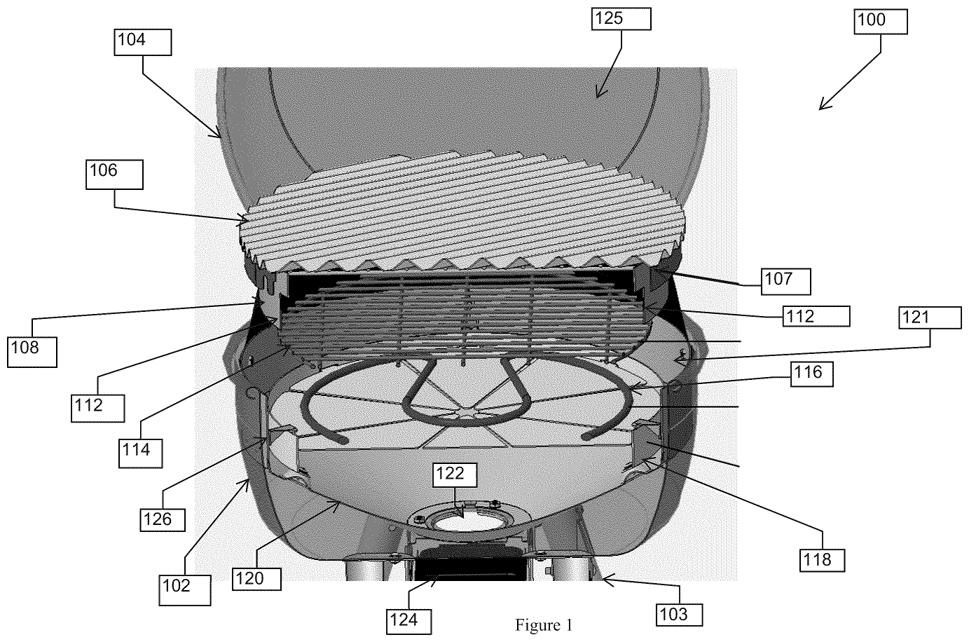

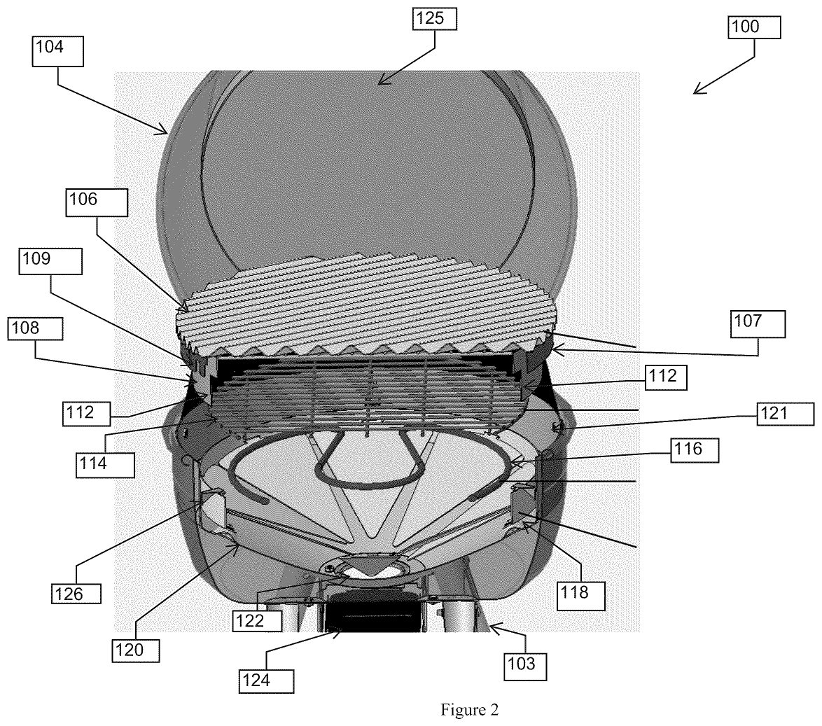

Referring now to FIG. 1 a perspective exploded cutaway view of one embodiment a grill 100 according to the present disclosure with a heat reflector 118 in an upward position is shown. Referring also to FIG. 2 a perspective exploded cutaway view of the grill 100 according to the present disclosure with the heat reflector 118 in a downward position is shown.

The grill 100 may include a firebox 102, possibly on a stand 103. An openable lid 104 may selectively cover the stand. A cooking grate 106 may provide a primary cooking surface. The cooking grate 106 may be constructed as known in the art, formed of various materials and having various kind of food support ribs and spacing. Below, and possibly affixed to, the cooking grate 106 is a push ring 108. The push ring 108 controls configurations of the reflector 118.

The push ring 108 may be raised and lowered (e.g., along with the cooking grate 106) to contact with the reflector 118 to open it and close it, respectively. One or more slots 112 or openings may be defined at various circumferential locations through part of push ring 108. The slots 112 allow the push ring 108 to be rotated into a position such that the push ring 108 extends fully downward to close the reflector 118. In such case, brackets 126 or other features inside the firebox 102 slide into or otherwise occupy the slots 112. When the push ring 108 is elevated and rotated such that brackets 126 or other features are not fitted into the slots 112, the push ring 108 may rest against such brackets 126 or other features and the push ring 108 is thereby prevented from lowering onto the reflector 118 and closing it.

Below the cooking grate 106 is a charcoal grate 114. The charcoal grate may be fixed within the firebox 102. Raising or lowering the push ring 108 may result in changing a distance between the charcoal grate 114 and the cooking grate 106 to allow for different sizes or amounts of charcoal and/or different cooking characteristics. As discussed further below, elevating the cooking grate 106 by rotating the push ring 108 to rest upon the brackets 126 also allows the reflector 118 to open for draining of ash or other cooking debris.

Interposing the reflector 118 and the cooking grate is a heating element 116. This may be above or below the charcoal grate 114. The electric heating element 116 may be an electric heating element as known to the art. When the electric heating element 116 is used, it may be instead of, or in addition to, the charcoal. The cooking grate 106 and push ring 108 may be lowered, which closes the reflector into the configuration shown in FIG. 1. This maximizes efficiency of the heating element 116 by reflecting heat back toward the cooking grate 106 that would be wasted by radiating downward otherwise. In some embodiments, a gas burner (not shown) may be used instead of, or in addition to, the electric heating element 116.

The firebox 102 may contain a funnel 120. The funnel 120 may be affixed to an interior of the firebox 102 and provide a mounting location for the reflector 118, brackets 126, and other items that are to be fixed within the firebox 102. An upper portion 121 of the funnel 120 may be substantially cylindrical and provide for attachment of the reflector 118 in an inner surface thereof (e.g., via the brackets 126). The push ring 108 may slide in and outward from the funnel 120 to open and close the reflector 118. Some embodiments of the grill may include an outer support ring 107 that circumscribes the push ring 108. The outer support ring 107 may have a diameter matching that of the upper portion 121 of the funnel 120 and may rest upon the upper portion 121 when the reflector is fully closed. In other embodiments, the support ring 107 may have a larger or smaller diameter that the upper portion of the funnel 121 to slide outside or inside the upper portion respectively. The support ring 107 may define notches or cutouts 109 when necessary to clear or accommodate support brackets 126.

The funnel 120 may terminate on a lower end at an opening 122, which may pass through a bottom end of the firebox 102 as well. This allows ash and other debris to fall or drain from the funnel and firebox 102. A grease cup 124 may be provided below the opening 122.

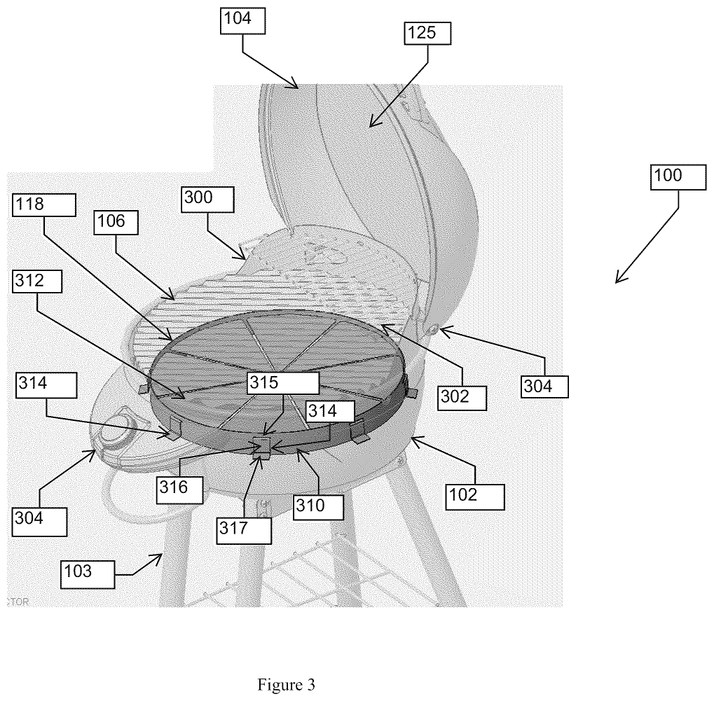

Referring now to FIG. 3, a perspective transparent view of the grill 100 highlighting the heat reflector 118 in the upward or closed position is shown. The reflector 118 may comprise an outer support ring 310 containing a number of movable blades, leaves, or panels 312. The panels 312 may be planar and may have a shape corresponding to a circle wedge or a sector of a disc. Each panel 312 may have an affixed tab 314 that passes to an outside of the support ring 310. The tabs 314 may pass through respective openings or slots 315 defined horizontally in the support ring 310. The tabs 314 may each comprise an offset 316 and an extension 317. Each extensions 317 may occupy a parallel plane to the corresponding panel 312. The offsets 316 may comprise a planar component that is offset 90 degrees from the plane of the respective panel 312 and the plane of the respective extension 317.

When the tabs 314 are pressed downward by the push ring 108, the panels 312 are levered into an upper position, as shown. The offset 316 may be situated or held between the push ring 108 and the support ring 310 in such configuration. The push ring 108 may rest on the extensions 317 when the panels 312 are in the upper position. The push ring 108 may contact the vertical offsets 316 and/or the extensions 317 when the panels 312 are being raised into the upper position. When the push ring 108 is elevated, removal of downward pressure on the tabs 314, allows the panels 312 to fall downward (e.g., as shown in FIG. 2). In such configuration, the push ring 108 may remain in contact with the extensions 317 and/or offsets 316. In some embodiments, a degree or distance to which the push ring 108 is elevated from its downward position (when the panels 312 are in their uppermost position) may control the final downward angle of the panels 312. In other embodiments, the panels 312 may be allowed to rest upon the cone 120 in their downward position.

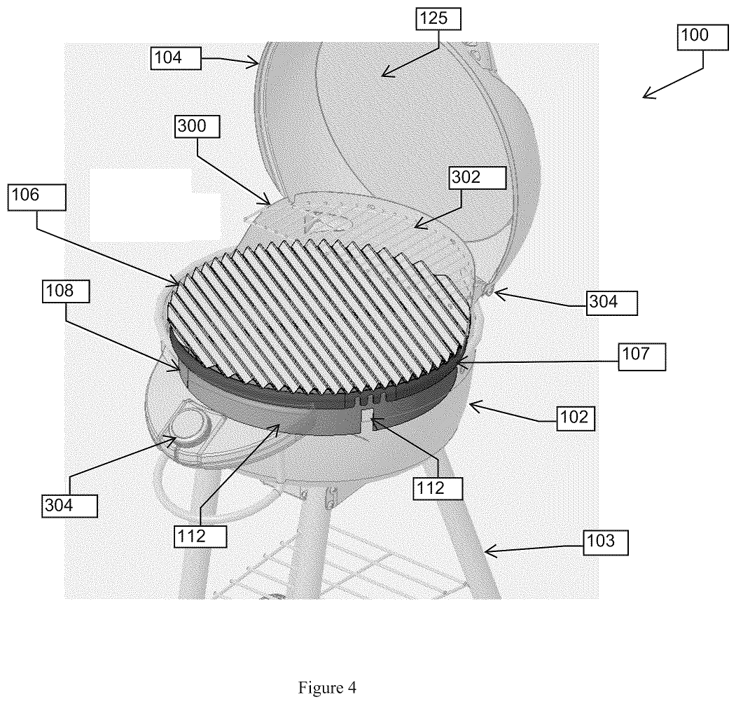

Referring now to FIG. 4, a perspective transparent view of one embodiment of the grill 100 highlighting the cooking grate 106 and push ring 108 is shown. Here the push ring 108 and cooking grate 106 are lowered. In this position the inner ring 110 bears or presses down upon the tabs 314 levering the panels 312 into the closed position.

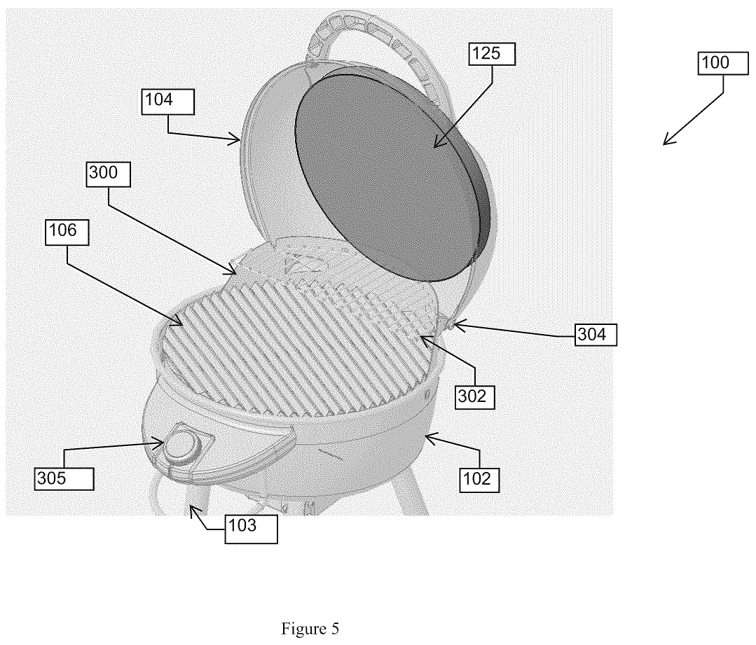

Referring now to FIG. 5, a perspective transparent view the grill 100 highlighting a storage location of a griddle 125 is shown. The griddle 125 may be removed from a storage location in the lid 104 and used in place of, or in addition to, the cooking grate 106. When the griddle 125 is not being used, it may be stored in the lid 104 as shown. This not only provides storage for the griddle 125, but also provides insulation in the lid 104. This results in both increased heat within the grill 100 but also a faster recovery time.

From the views of FIGS. 3-4 it can also be seen that the lid 104 may attach to hinges 304 fitted to a rear support 300. This may provide extra clearance for the lid 104 and extra room inside the grill 100. The rear support 300 may attach to, or otherwise be affixed with respect to, the firebox 102. Additional accessories, such as a warming rack 302, may also attach to the rear support 300. A control panel 304 for operating the electrical and/or gas components of the grill 100 may also attach to the front or elsewhere on the firebox 102.

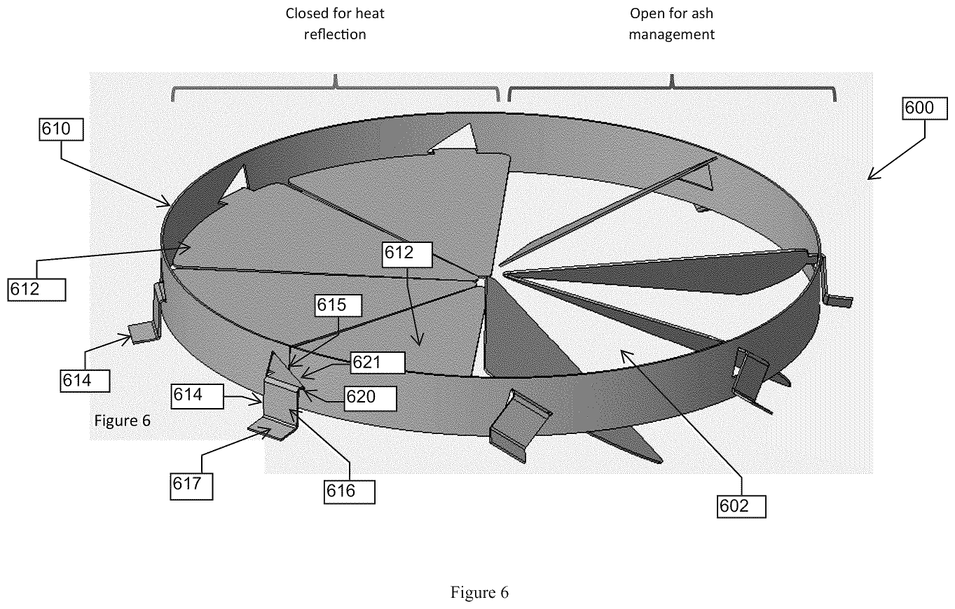

Referring now to FIG. 6, a perspective view of another embodiment of a reflector 600 is shown. The reflector 600 may be used in place of the reflector 118 in systems such as the grill 100 and similar. The reflector 600 may comprise a support ring 610 encircling a plurality of leaves, blades, or panels 612. The panels 612 may comprise planar circle wedges or sectors of a disc. The panels 612 may each be affixed to a tab 614 that may include an offset 616 connecting to an extension 617. Each extensions 617 may occupy a parallel plane to the corresponding panel 612. The offsets 616 may comprise a planar component that is offset 90 degrees from the plane of the respective panel 612 and the plane of the respective extension 617. The tabs 614 may be offset from a centerline of the respective panel 612.

The tabs 614 of the respective panels 612 may extend through the supporting ring 612 via openings 615 defined in the support ring. The openings 615 maybe triangular with a lower leg 620 in a horizontal or substantially horizontal orientation such that with the extension 617 retained in a downward or horizontal position, the respective panel 612 is held horizontal such that the panels 612 form a supportive surface inside the support ring 610. An upper leg 621 of the triangular openings 615 may have an incline allowing the panels 612 to rotate when pressure is released from the extensions 617.

Whether the panels 612 are open (e.g., rotated or tilted as in the right side of FIG. 6) or closed (e.g., as in the left side of FIG. 6) the offsets 616 may be trapped between the support ring 610 and the push ring 108 (FIG. 1) such that the tabs 614 of panels 612 are not permitted to fall through the openings 615. The push ring 108 may be lowered, pressing on the extensions 617 into a horizontal position to close the reflector 600. It may be elevated to allow the extensions 617, and therefore the panels 612, to tilt opening the reflector 600. The panels 612 may each rotate along an axis from the support ring 610 toward a center of the reflector 600. It should be understood that the panels 612 may all be equal or substantially equal in the degree of rotation exhibited during use.

It should be appreciated that the reflectors 118, 600 are in a closed configuration when their respective elements or panels 312, 612 are oriented parallel or substantially parallel to the cooking grate 106 with relatively narrow gaps (if any) between adjacent panels 312, 612. In this manner heat is evenly reflected back toward the cooking grate 106 that would otherwise be lost into the lower portions of the firebox 102. Additionally, the open configuration results in wide spaces between adjacent panels 312, 612 allowing ash to fall through the funnel 120 or firebox 102 and out of the grill 100.

In other embodiments, the reflector 118 may open and close by one or more mechanisms activated separately from movement of a push ring. A rotating ring with detents corresponding to the extensions 617 may open and close the reflector 600. A rotating shutter or iris mechanism may be used as an openable reflector in other embodiments. Handles for such mechanisms may be provided internally or via a slot or opening in the firebox 102.

Embodiments of the grill 100 and others described herein have multiple functions. Cooking performance is improved by eliminating excess air volume under the heating element 116, while the flaps or panels 312 are in a closed position. The proximity of this heat reflector 118 to the heating element 116 increases its temperature and makes it a very effective radiant heat emitter to the cooking grate 106. Embodiments utilizing the reflector 600 provide similar improvements. Secondly, the reflectors 118, 600 of the present disclosure may be used for grease management since it allows the grease to drain into a grease cup 124 or a tray attached to the bottom of the firepit 102. The conical or spherical shape and the steep slope/angle of the panels 312 (or 612) promote better grease drainage. Thirdly, while the panels 312/612 are in an open position, the reflector 118/600 drains ash produced when using the grill 100 in charcoal mode. In this case, ash will drop through the bottom of the funnel 120 and firepit 102 and consumers can access it without the need of removing parts inside the grill 100.

Differing sizes, heights, or elevations of the grate push ring 108 can allow difference in a distance between the cooking grate 106 and the charcoal grate 114, thereby allowing consumers to use charcoal as an alternative heat source. These may include: a low height or setting for placement of pellets; a medium height or setting for a single layer of briquettes or wood chunks as the primary heat source or as a smoke flavor source in conjunction with the heating element; and as a high height setting for large quantities of briquettes or lump charcoal.

In operation, the distance between the cooking grate 106 and the charcoal grate 114 will be relatively shorter or smaller when the push ring 108 is rotated such that brackets 126 are fitted into slots 112 resulting in the push ring closing the reflector 118. This allows the cooking grate 106 to be closer to the electrical heating element 116 for greater cooking efficiency, while at the same time the closed reflector 118 provides yet further electrical cooking efficiency. Distance between the cooking grate 106 and fuel grate 114 is also relatively reduced, though smaller amounts or sizes of charcoal, wood chips, or other combustibles may still be accommodated if desired. On the other hand, when the push ring 108 is lifted and rotated to rest upon the brackets 126, the reflector 118 will open, while distance between the cooking grate 106 and fuel grate 114 increases. This allows for larger sizes or amounts of combustible fuels, as well as ash and cooking debris drainage through the open reflector 118. In such a configuration, the electric cooking element 116 can still be employed to ignite the combustible and/or to provide supplemental heat.

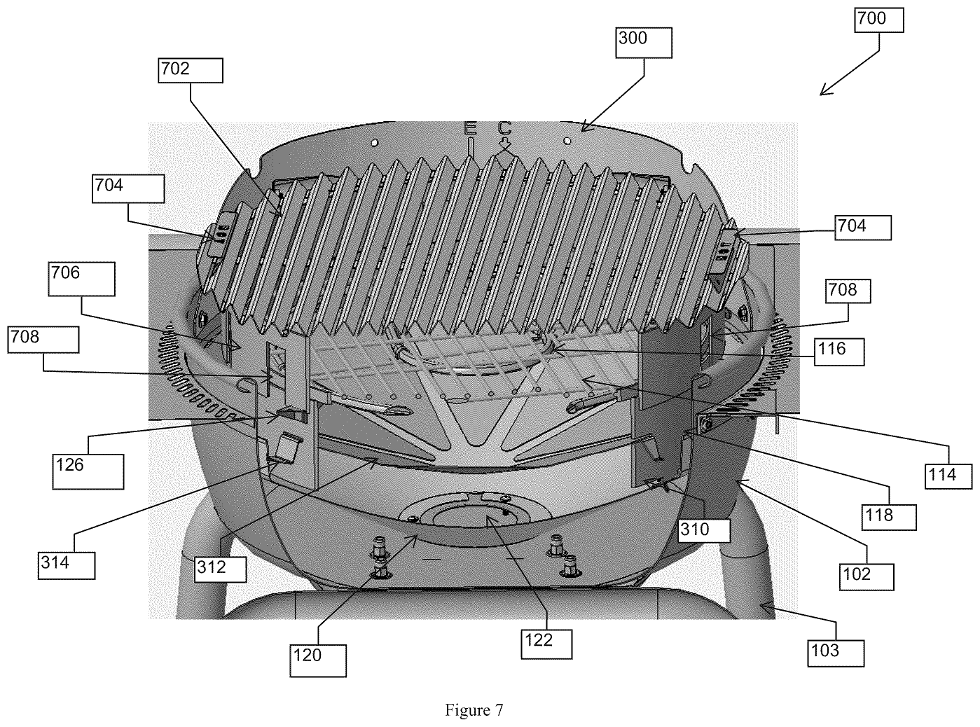

Referring now to FIG. 7, a perspective partial cutaway view of another embodiment of a multi-function grill 700 according to the present disclosure is shown. The grill 700 is substantially similar to the grill 100 with differences between the two being described below. A cooking grate 702 may provide a pair of spaced apart handles 704. The handles 704 may attach to the cooking grate 702 allowing manipulation of the cooking grate and push ring 706 affixed below or to a bottom of the cooking grate 702. The handles 704 may comprise a spring steel. The grill 700 may not include an outer support ring (e.g., 107, FIG. 1).

The push ring 706 functions substantially similar to the push ring 108 described above. The push ring 706 defines a plurality of slots 708 that can receive the brackets 126 when the push ring 706 is lowered to close the reflector 118 via contact with the tabs 314. The cooking grate 702 and push ring 706 may be lifted clear of the brackets 126 and away from the reflector 118 resulting in closure of the reflector 118. The cooking grate 702 and push ring 706 may then be rotated such that push ring 706 rests on the brackets 126. The position provides for greater space between the fuel grate 114 and the cooking grate 702 in a similar manner as described above with respect to the grill 100.

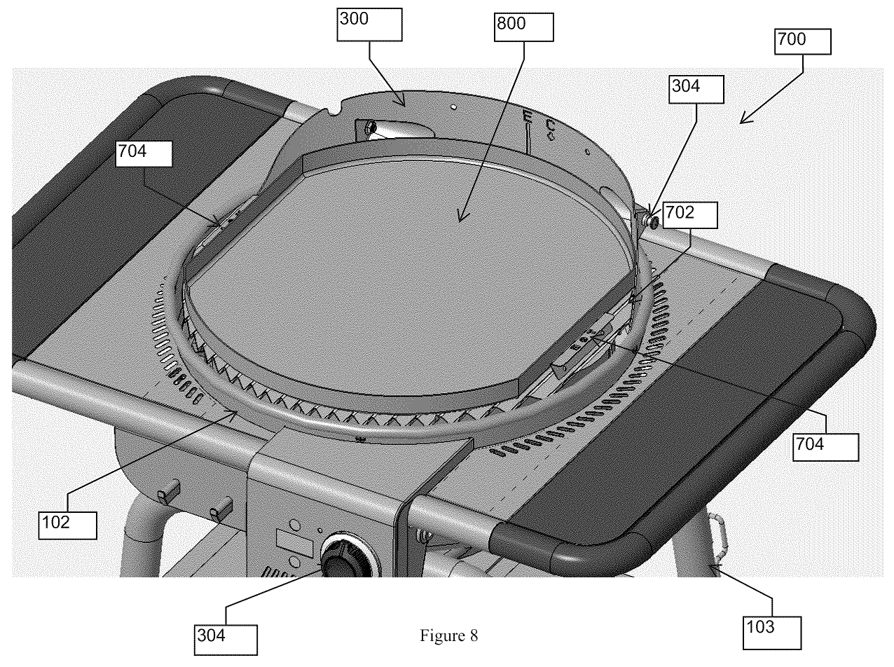

Referring now to FIG. 8, another perspective partial cutaway view of the grill 700 is shown. For clarity, no lid is shown. In the view of FIG. 8, the grill 700 is shown with the cooking grate 702 in the lowered position (which results in closure of the reflector 118 below). A griddle 800 is shown placed onto the cooking grate 702. The griddle 800 may comprise a circular device with straightened sides (e.g., a “double-D” configuration). The griddle 800 may be retained between the handles 704 when used for cooking. In some embodiments, more than two handles 704 may be provided on the cooking grate 702. In such case, the handles 704 may remain spaced apart so as to accommodate the griddle 800.

Both griddles 125, 800 offer multi-functional benefits. First, they are designed to optimize the energy use emitted by the heating element 116 by acting as a heat shield minimizing heat loss through the lid 104 and reducing air volume for a faster heat up time. With a griddle 125, 800 stored in the lid 104, temperatures at the cooking grate have been observed to be as much as 50° F. higher under otherwise similar cooking conditions. Secondly, the lid 104 may be a designated storage area for the griddle 125/800 inside the grill 100/700 respectively. While the griddle 125/800 is not in use, the material properties allow for heat to be reflected back down towards the cooking grate 106/702 and not lost by heat dissipation through the lid 104. Being able to store the griddle 125/800 inside the lid 104 prevents it from coming in contact with dirt, debris or exterior elements that would cause undesirable conditions when it is to be used again. Finally, one surface of this plate or griddle 125/800 can be used as a griddle while the reverse side can be used as pizza plate.

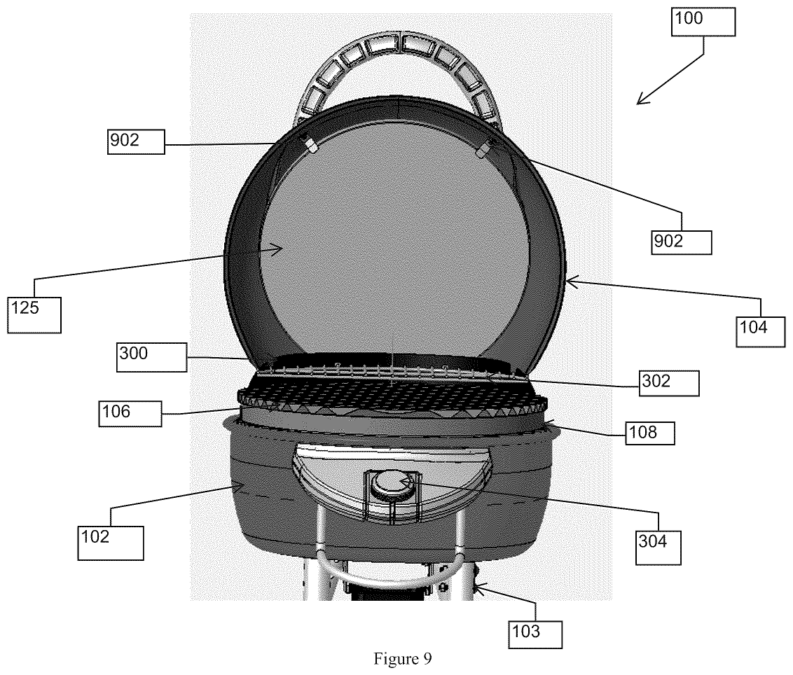

Referring now to FIG. 9, a front perspective view of the grill 100 showing a griddle storage arrangement. The griddle 125 may be secured into an underside of the lid 104 via plurality of clips 902 fixed to the lid 104 and spaced around a perimeter of the location of the griddle 125 when stored. The number of clips 902 may vary. The clips 902 may grasp the griddle 125 via an interference fit or another mechanism as known to the art. In some embodiments, there are three clips 902, with two toward a front of the lid 104 (as shown) and another clip (out of frame) toward a back of the lid 104. In some embodiments, one clip 902 is near the front and two are toward the back. In further embodiments, the clips 902 are equally or approximately equally spaced about the perimeter.

The grill 700 may be equipped with a similar lid 104. A similar arrangement of clips 902 may be used to retain the griddle 800 in the lid as well.

The design of the grill 100, 700 and other embodiments of the present disclosure provide higher cooking temperatures while in electric grilling and griddle cooking modes by focusing available energy to the cooking surface area and minimizing the heat loss to the environment. It also allows consumers the option of using alternative fuel source (charcoal) or to use electric as primary source and charcoal/pellets as a secondary source to add smoke flavor. This solution also allows the consumer an easier method of switching between one fuel to the other while keeping the heat reflection/ash management system in the correct position.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A reflector for use in a cooking grill comprising:
an outer support ring; and
a plurality of reflector panels with tabs attached thereto;
wherein the reflector panels are arranged inside the support ring with tabs outside the support ring;
wherein the tabs are displaced downward with respect to the support ring to move the reflector panels closer together to close the reflector; and
wherein the tabs are allowed to elevate thereby allowing the panels to move to increase an amount of space therebetween opening the reflector.

2. The reflector of claim 1, wherein the tabs are displaced downward by a push ring affixed to a cooking grate.

3. The reflector of claim 2, wherein the panels rotate along an axis to open the reflector.

4. The reflector of claim 3, wherein the tabs pass through the outer support ring via a plurality of openings that allow rotation of the reflector panels along an axis passing through the support ring.

5. The reflector of claim 4, wherein the plurality of openings are triangular.

6. The reflector of claim 2, wherein the panels rotate downward from the outer support ring to open the reflector.

7. The reflector of claim 6, wherein the tabs pass through the support ring via a plurality of horizontal slots in the outer support ring.

8. A grill comprising:
a firebox;
a food support grate;
a solid fuel support grate below the food support grate;
a reflector inside the firebox comprising a plurality of reflector panels that have a closed configuration reflecting heat to the food support grate and an open configuration where a reduced amount of heat is reflected; and
an electric heating element above the reflector.

9. The grill of claim 8, wherein the reflector panels are retained by a support ring.

10. The grill of claim 9, wherein the reflector panels drop from below a center of the food support grate to move to the open configuration.

11. The grill claim 9, wherein each of the plurality of reflector panels rotate along an axis running through the support ring to move into the open configuration.

12. The grill of claim 8, wherein the reflector panels each have an attached tab that is displaced to move the reflector panels into the closed configuration.

13. The grill of claim 12, wherein the tabs are displaced by a push ring affixed to the cooking grate.

14. The grill of claim 13, wherein the tabs are displaced downward to move the panels into the closed configuration.

15. The grill of claim 14, further comprising a funnel inside the firebox circumscribing the reflector panels.

16. The grill of claim 15, further comprising an opening defined in a bottom of the firebox at below the funnel.

17. The grill of claim 13, wherein the push ring defines a plurality of slots for interfacing with at least one protrusion in the firebox for setting a predetermined elevation of the push ring.

18. A grill comprising:
a cooking grate;
a fuel support grate below the cooking grate;
an electric heating element below the cooking grate;
a reflector below the heating element comprising a plurality of reflector panels each having a push tab and each having a first position oriented parallel to the cooking grate and a second position oriented non-parallel to the cooking grate;
a support ring retaining the plurality of reflector panels inside the support ring and each of the push tabs outside the support ring when the reflector panels are in the first position; and
a push ring affixed to a bottom of the cooking grate, wherein the push ring engages the push tab on each of the plurality of reflector panels to move the plurality of reflector panels to the first position.

19. The grill of claim 18, further comprising a lid that covers the cooking grate and has a plurality of clips retaining a griddle in a storage location in the lid.

20. The grill of claim 19, further comprising a plurality of handles affixed to the cooking grate and being spaced apart to accommodate placement of the griddle onto the cooking grate.
